(19) United States
(12) Patent Application Publication
(10) Pub. No.: US 2013/0286303 A1
(43) Pub. Date: Oct. 31, 2013

(54) SHUTTER EYEGLASSES DEVICE

(71) Applicants: Kenichi Shibuya, Kanagawa (JP); Yuji Oikawa, Kanagawa (JP); Roger Corn, Tokyo (JP)

(72) Inventors: Kenichi Shibuya, Kanagawa (JP); Yuji Oikawa, Kanagawa (JP); Roger Corn, Tokyo (JP)

(73) Assignee: SONY CORPORATION, Tokyo (JP)

(21) Appl. No.: 13/880,556

(22) PCT Filed: Jun. 12, 2012
(86) PCT No.: PCT/JP2012/065015

§ 371 Date: Apr. 19, 2013

(30) Foreign Application Priority Data
Aug. 30, 2011 (JP) 2011-187977

(51) Int. Cl. G02B 27/22

(52) U.S. Cl. CPC G02B 27/2264
USPC 349/13

(57) ABSTRACT

There is provided a superior shutter glass device that has a simple and light-weight structure, has a high degree of designability, and is fitted to each wearing user.

Shutter glasses 400 form a structure body in which a transparent front shield 401 to which left and right liquid crystal shutters 403L and 403R are bonded is supported by a front frame 407. On both left and right ends of the front frame 407, left and right temples 402L and 402R are supported so as to be open or closed. The shutter glasses 400 supporting the liquid crystal shutters 403L and 403R using the front shield 401 are simple, light-weight, and have superior designability.

### TECHNICAL FIELD

The technology disclosed in this specification relates to a shutter glass device and, for example, relates to a shutter glass device for watching a stereoscopic video displaying left and right videos in a time divisional manner.

### BACKGROUND ART

By displaying images having disparity therebetween to left and right eyes, a stereoscopic image that is seen to be stereoscopic by an observer can be presented. As one of modes for presenting a stereoscopic image, there is a mode in which images having disparity therebetween is presented to both eyes by allowing an observer to wear glasses having special optical characteristics.

For example, a time-divisional stereoscopic image display system is configured by a combination of a display apparatus displaying a plurality of mutually-different images in a time divisional manner and shutter glasses worn by an observer of the images. The display apparatus alternately displays a left-eye image and a right-eye image with a very short cycle. On the other hand, the shutter glasses worn by the observer include shutter mechanisms each configured by a liquid crystal shutter and the like in left-eye and right-eye parts. In the shutter glasses, while a left-eye image is displayed, the left-eye part of the shutter glasses transmits light, and the right-eye part shields light. In addition, while a right-eye image is displayed, the right-eye part of the shutter glasses transmits light, and the left-eye part shields light (for example, see Patent Documents 1 to 3). In other words, the display apparatus performs a time-divisional display of a left-eye image and a right-eye image, and the shutter glasses select images using the shutter mechanisms in synchronization with switching between displays of the display apparatus, whereby the left-eye image and the right-eye image are fused so as to be a stereoscopic image inside the observing user's brain.

Many conventional shutter glasses, similarly to glasses for vision correction, are structure bodies in which liquid crystal shutters are supported at left and right glass frames (for example, see Patent Document 4). The glass frame, generally, has left and right temples (earpieces of glasses) for being worn by the ears, and the temples are supported by hinges to be rotatable at glass frames (rims) fixing the lenses by hinges.

As the material of the glass frame or the temple unit of such a type, metal (a nickel•titanium alloy, gold, a shape memory alloy, or the like) or plastic (an acetate material or an ultrasonic resin) is frequently used, which is expensive. In addition, the structure is relatively complex, and, in order to perform fitting such as fine adjustment (plastic deformation) of the shape, a specialized skillful technique, a specialized device, and a specialized jig are necessary.

Glasses for vision correction, basically, are for a personal use and are purchased at glass specialty shops, and accordingly, the price is adequate, and it is preferable to perform fitting of the frames on the store side at the time of delivering the product. In contrast to this, the shutter glasses are supplements of a 3D-supporting television set and are low-priced. In addition, while the shutter glasses are sold at the same stores as those of 3D-supporting television sets, it cannot be premised that sales persons are skilled in the fitting of glasses. In addition, since there are many cases where one pair of shutter glasses is used to be common to a plurality of users watching the same 3D-supporting television set, it is meaningless to perform fitting for a single user.

Furthermore, the structure bodies that support the left and right liquid crystal shutters at the glass frames cause an oppressive feeling on the glass frames disposed on the front face and may be regarded to have insufficient designability.

### CITATION LIST

### Patent Documents

Patent Document 1: Japanese Patent Application Laid-Open No. 9-138384
Patent Document 2: Japanese Patent Application Laid-Open No. 2000-36969
Patent Document 3: Japanese Patent Application Laid-Open No. 2003-45343
Patent Document 4: Japanese Patent Application Laid-Open No. 2011-125013

### SUMMARY OF THE INVENTION

### Problems to be Solved by the Invention

An object of the technology disclosed in this specification is to provide a superior shutter glass device that is appropriately used when a stereoscopic video displaying left and right videos in a time-divisional manner is watched.

In addition, another object of the technology disclosed in this specification is to provide a superior shutter glass device that has a simple and light-weight structure, has a high degree of designability, and is fitted to each wearing user.

### Solution to Problems

The present application has been made in view of the above problems, and the technology described in claim 1 is a shutter glass device including:

a left-eye liquid crystal shutter unit;

a right-eye liquid crystal shutter unit;

a transparent shield on which the left-eye liquid crystal shutter unit and the right-eye liquid crystal shutter unit are installed;

a frame unit that supports the shield; and

temple units that are connected to both left and right ends of the frame unit.

According to the technology described in claim 2, in the shutter glass device according to claim 1, the left-eye liquid crystal shutter unit and the right-eye liquid crystal shutter unit are bonded to a rear-face side of the shield.

According to the technology described in claim 3, in the shutter glass device according to claim 1, the frame unit is made from pure titanium, and the temple units are made from a titanium alloy.

According to the technology described in claim 4, in the shutter glass device according to claim 1, rear-side portions of the temple units bend toward the inner side.

According to the technology described in claim 5, the shutter glass device according to claim 1 further includes earpiece parts that are installed near rear ends of the temple units.

According to the technology described in claim 6, in the shutter glass device according to claim 5, the position of the earpiece part can be changed to a front or rear side along a longitudinal direction of the temple units.

According to the technology described in claim 7, in the shutter glass device according to claim 5, the earpiece parts are manufactured in the shape of letter “V” using elastomer-based silicon or any other flexible material, a front leg of the letter “V” includes a bending portion, and a radius of curvature of the bending portion changes in accordance with a width with which legs of the letter “V” are open.

According to the technology described in claim 8, in the shutter glass device according to claim 3, the frame unit includes bending portions bending to a rear side in both left and right ends. The temple units are supported by the frame unit to be rotatable using hinges disposed on a further end edge side than the bending portions.

According to the technology described in claim 9, the shutter glass device according to claim 1 further includes, on a rear-face side of the frame unit, an electric component housing part attached in a gap between the left-eye liquid crystal shutter unit and the right-eye liquid crystal shutter unit.

According to the technology described in claim 10, in the shutter glass device according to claim 9, the electric component housing part houses a shutter driving circuit of the left-eye liquid crystal shutter unit and the right-eye liquid crystal shutter unit, a communication circuit that performs a reception process of an infrared signal or an RF signal, and a battery that supplies power to circuits.

According to the technology described in claim 11, in the shutter glass device according to claim 9, in the electric component housing part, two, three, or more printed circuit boards used for mounting housed electric components are arranged in an overlapping manner.

According to the technology described in claim 12, in the shutter glass device according to claim 1, the frame unit supports the shield in a center portion.

According to the technology described in claim 13, in the shutter glass device according to claim 1, the shield is made from an acrylic resin that is injection-molded.

According to the technology described in claim 14, in the shutter glass device according to claim 13, an IMD film is simultaneously molded on a surface of a front-face side of the shield.

According to the technology described in claim 15, in the shutter glass device according to claim 13, the shield is molded so as to suppress birefringence.

According to the technology described in claim 16, in the shutter glass device according to claim 13, the shield is injection-molded using a fan gate.

### EFFECTS OF THE INVENTION

According to the technology disclosed in this specification, there can be provided a superior shutter glass device that has a simple and light-weight structure, has a high degree of designability, and is fitted to each wearing user.

The other objects, features, and advantages of the technology disclosed in this specification will become apparent by detailed description of exemplary embodiments to be described later and the attached drawings.

### BRIEF DESCRIPTION OF DRAWINGS

FIG. 1 is a schematic diagram of a configuration example of an image displaying system.

FIG. 2 is a diagram that illustrates an internal configuration example of shutter glasses 13.

FIG. 3A is a diagram that illustrates the operation of controlling left and right liquid crystal shutters 308 and 309 of the shutter glasses 13 synchronized with a display period of a left-eye image L of a display apparatus 11.

FIG. 3B is a diagram that illustrates the operation of controlling the left and right liquid crystal shutters 308 and 309 of the shutter glasses 13 synchronized with a display period of a right-eye image R of the display apparatus 11.

FIG. 4A is a front view of shutter glasses 400 according to an embodiment of technology disclosed in this specification.

FIG. 4B is a rear view of the shutter glasses 400 according to an embodiment of the technology disclosed in this specification.

FIG. 4C is a right-side view of the shutter glasses 400 according to an embodiment of the technology disclosed in this specification.

FIG. 4D is a left-side view of the shutter glasses 400 according to an embodiment of the technology disclosed in this specification.

FIG. 4E is a top view of the shutter glasses 400 according to an embodiment of the technology disclosed in this specification.

FIG. 4F is a bottom view of the shutter glasses 400 according to an embodiment of the technology disclosed in this specification.

FIG. 4G is a perspective view of the shutter glasses 400 according to an embodiment of the technology disclosed in this specification.

FIG. 4H is a perspective view of the shutter glasses 400 according to an embodiment of the technology disclosed in this specification.

FIG. 5 is a diagram that illustrates earpiece parts 406L and 406R disposed near rear ends of left and right temples 402L and 402R in an enlarged scale.

FIG. 6A is a perspective view of the shutter glasses 400 in which hinges 408L and 408R connecting a front frame 407 to the temples 402L and 402R are also illustrated.

FIG. 6B is a perspective view of the shutter glasses 400 in which a portion near the hinge 408R is enlarged.

FIG. 7 is a diagram in which the rear-face side

(the side of the face of a user wearing the shutter glasses) of a front shield 401 is enlarged.

FIG. 8A is a diagram that illustrates an internal configuration example of an electric component housing part 404.

FIG. 8B is a cross-sectional view of the electric component housing part 404.

FIG. 9 is a diagram that illustrates a portion supporting the front shield 401 near the center of the front frame 407 in an enlarged scale.

FIG. 10A is a diagram that illustrates the appearance of bonding the liquid crystal shutters 403L and 403R to the surface of the front shield 401.

FIG. 10B is a cross-sectional view of the front shield 401 after the liquid crystal shutter 403L is attached thereto.

FIG. 11 is a diagram that illustrates the appearance of the front shield 401 projected from the front-face side.

FIG. 12 is a diagram that illustrates an IMD film molded simultaneously with the front shield 401.

FIG. 13 is a diagram that illustrates the appearance in which a display video supplied from the display apparatus 11 is transmitted through the front shield 401 and is shielded by the liquid crystal shutter 403.

FIG. 14 is a diagram that illustrates the appearance of light leaking when a molding component having birefringence is inserted between two polarizing plates of which the polarization directions are perpendicular to each other.

FIG. 15A is a diagram that illustrates a method of mold injection of the front shield 401 using a side gate.

FIG. 15B is a diagram that illustrates a method of mold injection of the front shield 401 using a direct gate.

FIG. 15C is a diagram that illustrates a method of mold injection of the front shield 401 using a fan gate.

### MODE FOR CARRYING OUT THE INVENTION

Hereinafter, embodiments of the technology disclosed in this specification will be described in detail with reference to the drawings.

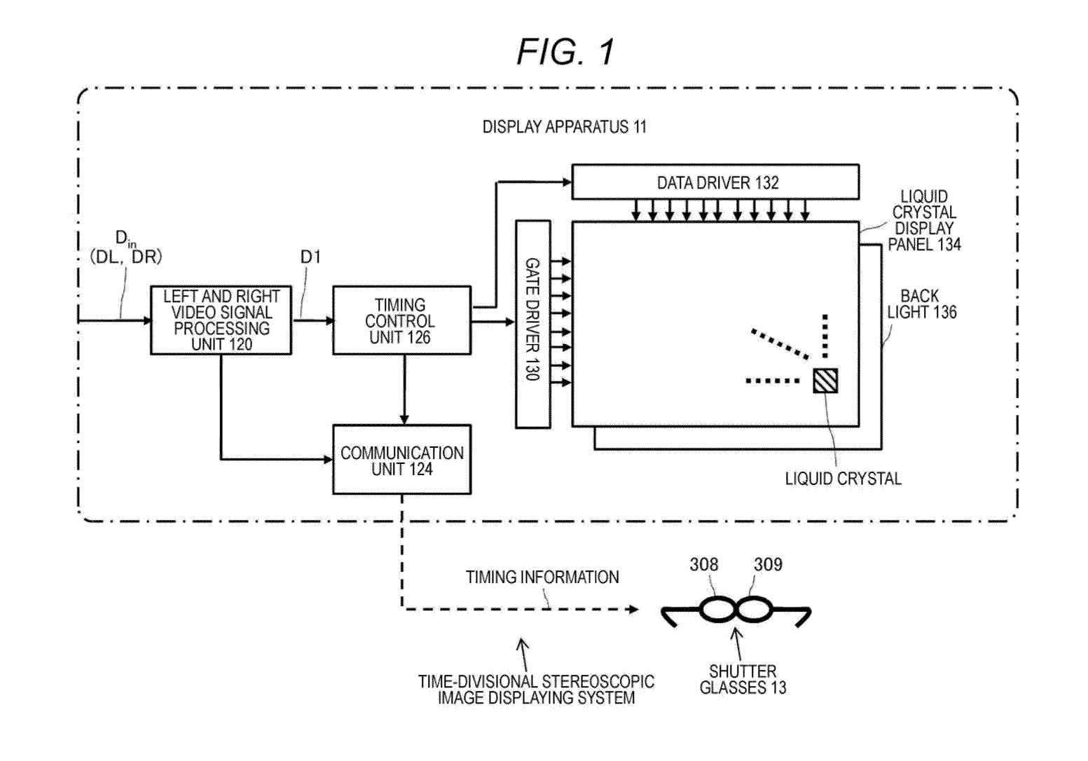

FIG. 1 schematically illustrates a configuration example of a time-divisional stereoscopic image displaying system. The time-divisional stereoscopic image displaying system is formed by a combination of a display apparatus 11 supporting a three dimensional display (three-dimensional view) and shutter glasses 13 including shutter mechanisms in left-eye and right-eye parts. The display apparatus 11 alternately displays a left-eye image L and a right-eye image R in a frame sequential mode. On the other hand, the shutter glasses 13 changes the opening/closing of left and right liquid crystal shutters 308 and 309 in synchronization with the timing of switching between the left-eye image L and the right-eye image R on the display apparatus 11 side. Hereinafter, it is assumed that a liquid crystal display (LCD) is used as the display apparatus 11 used for a display of a three-dimension image. However, the concept of the technology disclosed in this specification is not necessarily limited to the liquid crystal display.

The display apparatus 11 includes a left and right image signal processing unit 120, a communication unit 124, a timing control unit 126, a gate driver 130, a data driver 132, and a liquid crystal display panel 134.

The liquid crystal display panel 134 is configured by a liquid crystal layer, a transparent electrode and a color filter layer (any of these is not illustrated in the figure) that face each other with the liquid crystal layer interposed therebetween, and the like. In addition, on the rear side of the liquid crystal display panel 134, a back light (surface light source) 136 is arranged. The back light 136 is configured by an LED (Light Emitting Diode) having a good persistence characteristic or the like. In addition, on the surface of the display screen, a polarizing plate not illustrated in the figure is arranged.

An input signal Dᵢₙ formed from left and right image signals DL and DR used for displaying a left-eye image R and a right-eye image L are input to the left and right image signal processing unit 120 in a transmission format, for example, a frame packing format. Inside the left and right image signal processing unit 120, an image quality correcting process such as enhancement of the sharpness of an image or contrast enhancement is performed. In order to display the left-eye image L and the right-eye image R on the liquid crystal display panel 134 in a frame sequential mode, the left and right image signal processing unit 120 alternately outputs the left and right image signals DL and DR.

The left-eye image signal DL and the right-eye image signal DR that are converted by the left and right image signal processing unit 120 are input to the timing control unit 126. The timing control unit 126 converts the left-eye image signal DL and the right-eye image signal DR, which have been input, into signals for being input to the liquid crystal display panel 134 and generates a pulse signal that is used for the operation of a panel driving circuit formed by the gate driver 130 and the data driver 132. Here, the gate driver 130 is a driving circuit generating signals for sequential driving and outputs a driving voltage to a gate bus line connected to each pixel disposed inside the liquid crystal display panel 134 in accordance with a signal transmitted from the timing control unit 126. In addition, the data driver 132 is a driving circuit outputting a driving voltage based on a video signal and generates and outputs a signal to be applied to a data line based on a signal transmitted from the timing control unit 126.

For communication between the display apparatus 11 and the shutter glasses 13, a wireless network such as infrared communication, Wi-Fi, IEEE 802.15.4, IEEE 802.15.1 (Bluetooth communication), or the like is used. The communication unit 124 transmits an information signal that is necessary for controlling the timing of the opening/closing of the left and right liquid crystal shutters 308 and 309 to the shutter glasses 13.

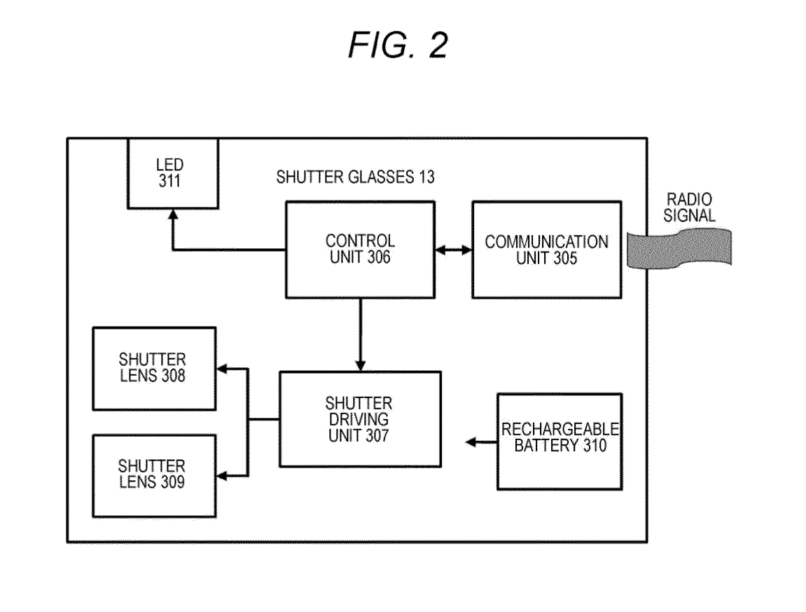

FIG. 2 illustrates an internal configuration example of the shutter glasses 13. The shutter glasses 13 include: a communication unit 305 that performs the process of receiving an information signal transmitted from the display apparatus 11; a control unit 306; a left-eye liquid crystal shutter 308 and a right-eye liquid crystal shutter 309 each formed from a liquid crystal material; a shutter driving circuit 307; a rechargeable battery 310 as a main power source; and an LED indicator 311 that displays the operating status and the like. The rechargeable battery 310 can be charged using a commercial AC power source or the like by connecting a charging cable to a charging connector not illustrated in the figure. The shutter glasses 13 start the operation by inputting power thereto by operating a power button not illustrated in the figure in FIG. 2.

A synchronization packet is transmitted in a wireless manner from the display apparatus 11 to the shutter glasses 13. In a single synchronization packet, in addition to information relating to the opening/closing timing of the left and right liquid crystal shutters 308 and 309 disposed on the shutter glass 13 side, control information instructing switching between display modes is included. When an information signal is received from the display apparatus 11, the communication unit 305 inputs the information signal to the control unit 306. The control unit 306 demodulates and decodes the information signal, analyzes the written content thereof, determines the opening/closing timings of the left and right liquid crystal shutters 308 and 309, and controls the opening/closing operations of the left and right liquid crystal shutters 308 and 309 through the shutter driving circuit 307.

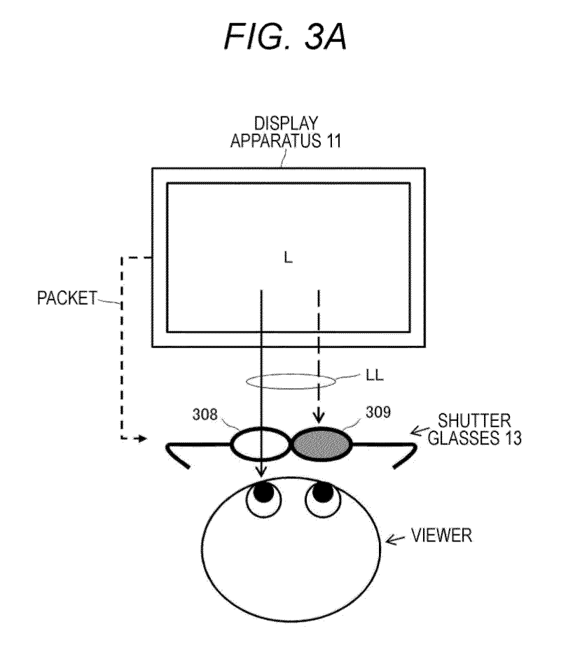

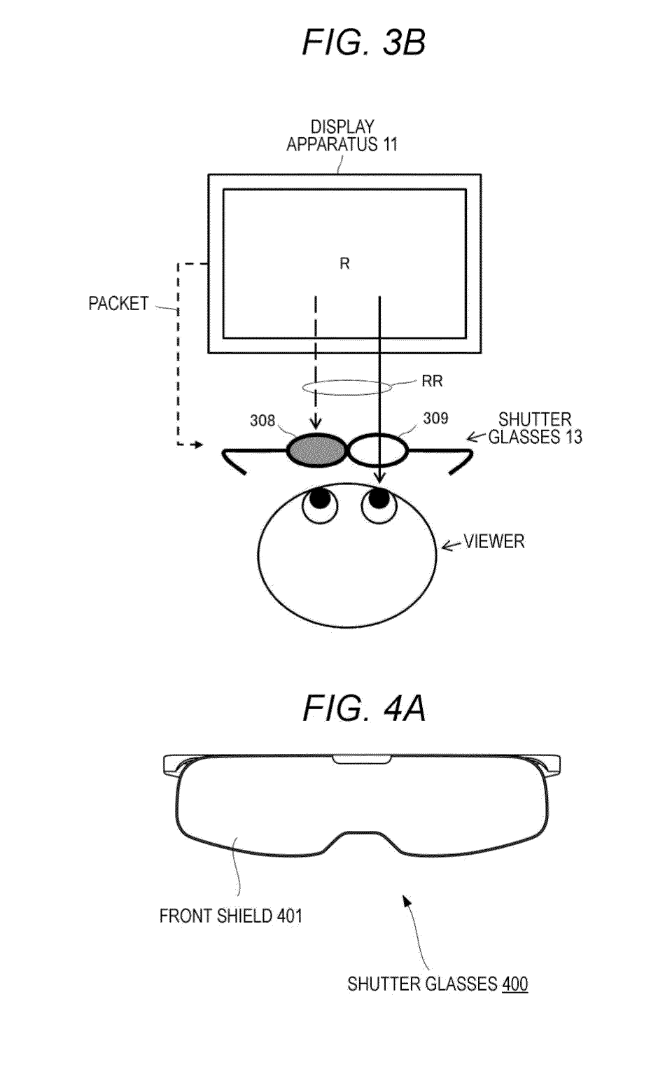

The shutter glasses 13 can take the synchronization with a frame sequence of the display apparatus 11 in accordance with the information signal transmitted from the display apparatus 11 side. FIG. 3A illustrates an operation of controlling the liquid crystal shutters 308 and 309 of the shutter glasses 13 that are in synchronization with a display period of the left-eye image L of the display apparatus 11. As illustrated in the figure, in the display period of the left-eye image L, the left-eye liquid crystal shutter 308 is in the open state, and the right-eye liquid crystal shutter 309 is in the closed state, whereby display light LL based on the left-eye image L arrives only at the user's left eye. FIG. 3B illustrates an operation of controlling the liquid crystal shutters 308 and 309 of the shutter glasses 13 that are in synchronization with a display period of the right-eye image R. As illustrated in the figure, in the display period of the right-eye image R, the right-eye liquid crystal shutter 309 is in the open state, and the left-eye liquid crystal shutter 308 is in the closed state, whereby display light RR based on the right-eye image R arrives only at the user's right eye.

The display apparatus 11 alternately displays the left-eye image L and the right-eye image R on the liquid crystal display panel 134 for each field. On the shutter glasses 13 side, the left and right liquid crystal shutters 308 and 309 alternately perform opening and closing operations in synchronization with the switching between images for each field of the display apparatus 11. Inside the brain of a user observing a display image over the shutter glasses 13, the left-eye image L and the right-eye image R are fused, whereby an image displayed on the display apparatus 11 is stereoscopically recognized.

Many conventional shutter glasses, similarly to glasses for vision correction, are structure bodies in which left and right liquid crystal shutters are supported by the glass frame and have disadvantages of causing an oppressive feeling, being insufficient designability, being high priced, being heavily weighted, and the like. In contrast to this, in this specification, shutter glasses, in which the liquid crystal shutters are supported without using the glass frame, having superior designability is proposed.

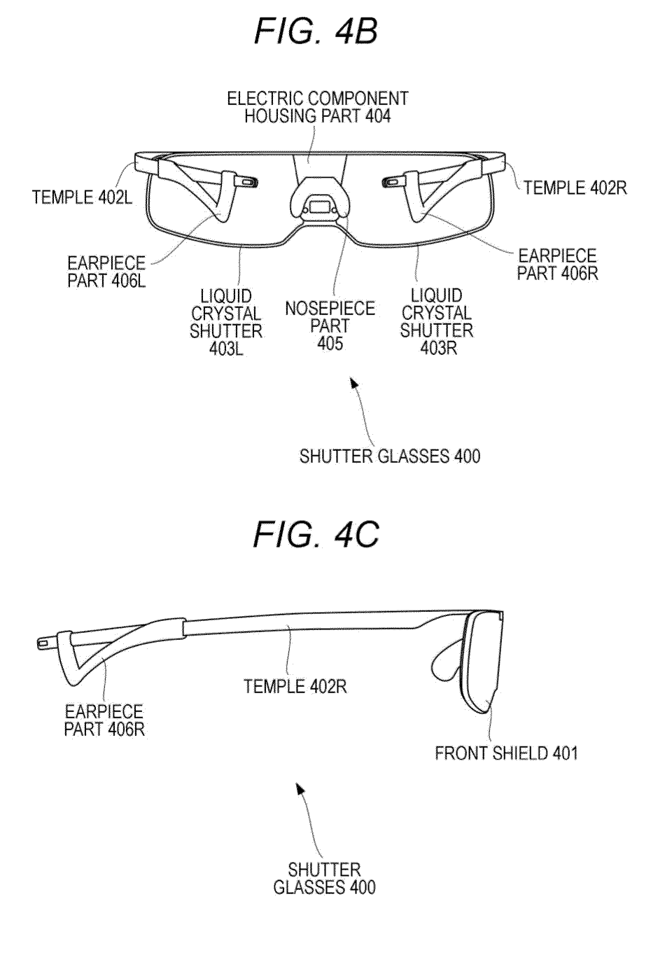

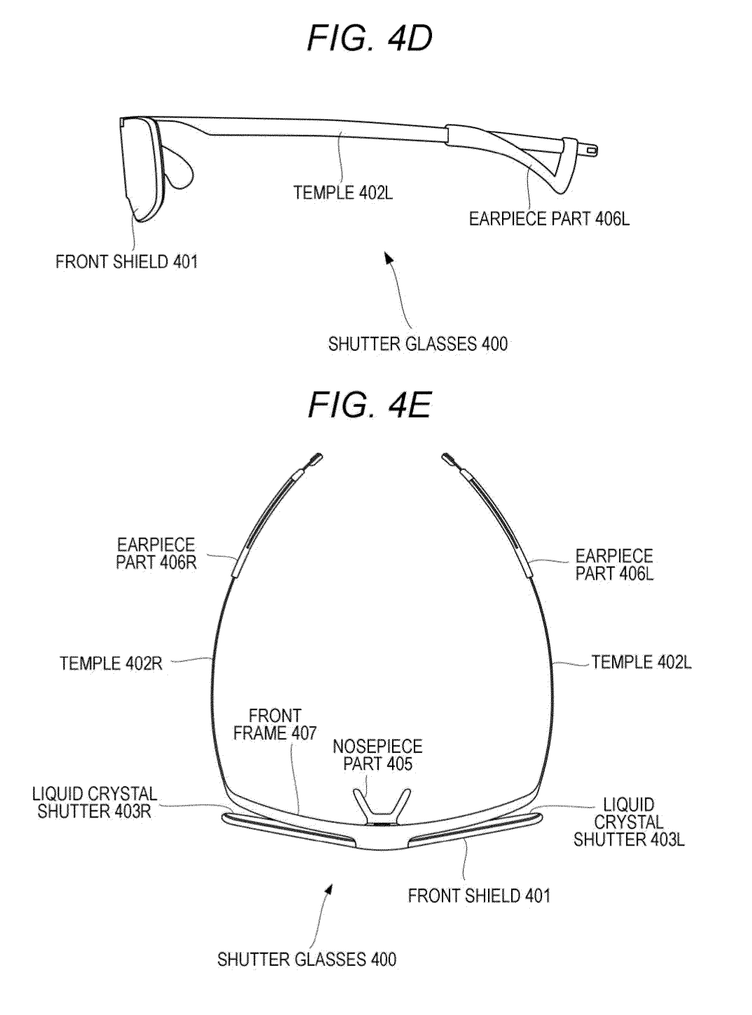

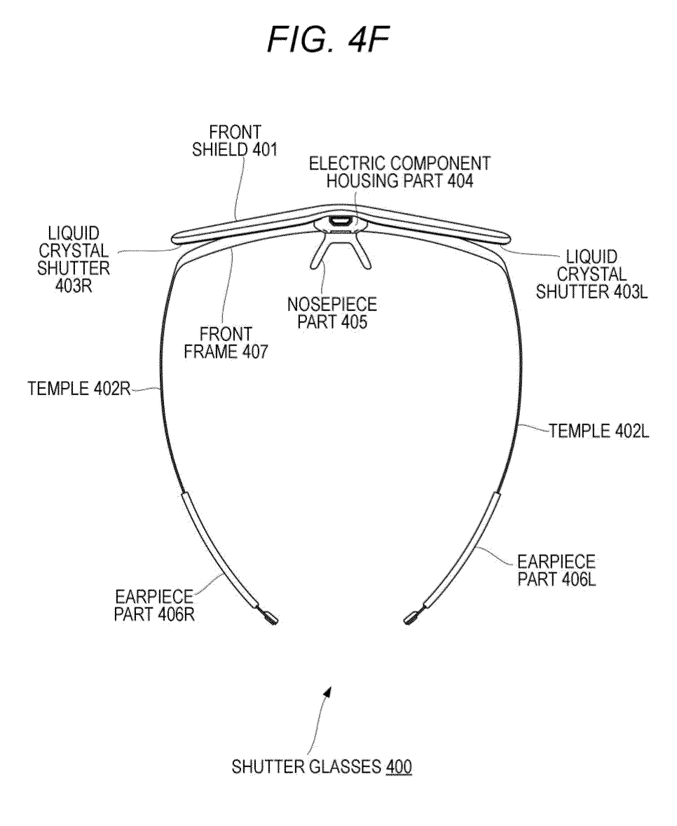

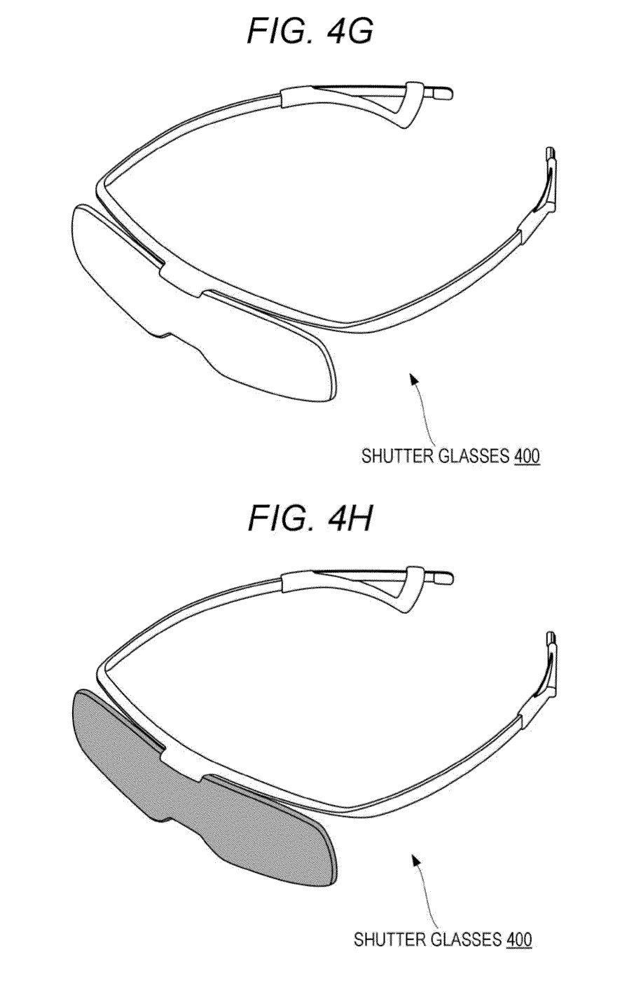

FIG. 4 illustrates the external configuration of the shutter glasses 400 according to an embodiment of the technology disclosed in this specification. FIG. 4A is a front view of the shutter glasses 400, FIG. 4B is a rear view of the shutter glasses 400, FIG. 4C is a right-side view of the shutter glasses 400, FIG. 4D is a left-side view of the shutter glasses 400, FIG. 4E is a top view of the shutter glasses 400, FIG. 4F is a bottom view of the shutter glasses 400, and FIGS. 4G and 4H are perspective views of the shutter glasses 400.

The shutter glasses 400 illustrated in the figure form a structure body in which a transparent front shield 401, to which left and right liquid crystal shutters 403L and 403R are attached on the rear face (the side of the face of a user wearing the shutter glasses), is supported by a front frame 407. In addition, on both left and right ends of the front frame 407, left and right temples 402L and 402R are supported to be open or closed through hinges (not illustrated in FIG. 4). As can be understood from the perspective views illustrated in FIGS. 4G and 4H, the shutter glasses 400 in which the left and right liquid crystal shutters 403L and 403R are supported by the front shield 401 are simple and light-weight and have superior designability, compared to a conventional structure body in which the liquid crystal shutters are supported by the glass frame.

The left and right temples 402L and 402R, in consideration of the flexibility at the time of being worn by a user, is manufactured, for example, by using a titanium alloy (β titanium). On the other hand, the front frame 407, in consideration of maintaining the shape, is manufactured, for example, by using pure titanium (α titanium).

As can be understood from the top view illustrated in FIG. 4E and the bottom view illustrated in FIG. 4F, rear portions of the left and right temples 402L and 402R bend toward the inner side, and the radius of curvature thereof increases toward the rear end.

In general glasses for vision correction or the like, left and right temples are caught at the earlobes, and a nosepiece part is brought into contact with a nose head, whereby the glasses are supported at the three points. Accordingly, a fitting operation is necessary in which the end edge portions of the temples are bent toward the lower side so as to fit the size of the head and the shape of the ears of a user wearing the glasses, and, after the fitting, the glasses are not comfortably put on by other users. In contrast to this, according to the shutter glasses 400 of this embodiment, instead of hooking the left and right temples 402L and 402R into the earlobes, the shutter glasses are supported by instant pressure generated when bending portions going toward the inner side are brought into contact with rear head portions of a user. Accordingly, the shutter glasses fit a plurality of users having mutually different sizes of the head parts without performing fitting. The left and right temples 402L and 402R, as described above, are made from a titanium alloy, have a sufficient spring characteristic, and can sufficiently respond to a difference in the size of the head part by being bent.

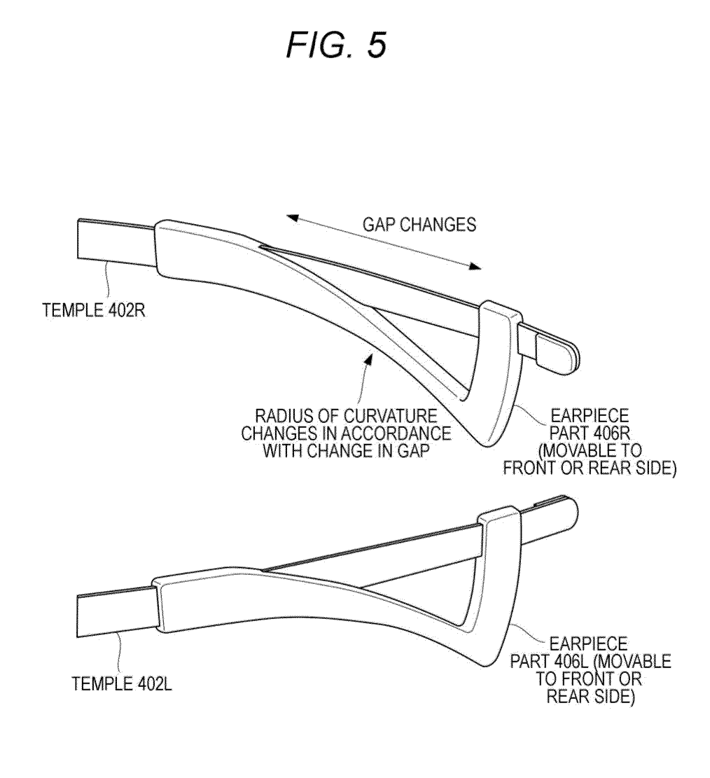

In addition, near rear ends of the left and right temples 402L and 402R, the earpiece parts 406L and 406R are attached. FIG. 5 illustrates the earpiece parts 406L and 406R disposed near the rear ends of the left and right temples 402L and 402R in an enlarged scale. As illustrated in the figure, the earpiece parts 406L and 406R respectively have the shape of approximate letter “V”, and, in the tip ends of both legs having the shape of letter “V”, openings are formed, and the earpiece parts are attached by inserting the temples 402L and 402R into one set of the openings. Accordingly, the front and rear positions of the earpiece parts 406L and 406R can be changed by moving one set of the openings in the longitudinal direction of the temples 402L and 402R. The earpiece parts 406L and 406R are manufactured using a flexible material such as elastomer-based silicon and is freely transformed. In addition, out of two legs of the earpiece parts 406L and 406R, front-side legs brought into contact with the ears bend. For example, by transforming the earpiece parts 406L and 406R, a width (an opening width of the letter “V”) between both tip ends can be expanded or contracted, and accordingly, the radius of curvature of the bending portions of the front legs of the earpiece parts 406L and 406 changes, whereby the earpiece parts can be made to fit the shape of the rear sides of the ear conches of a user.

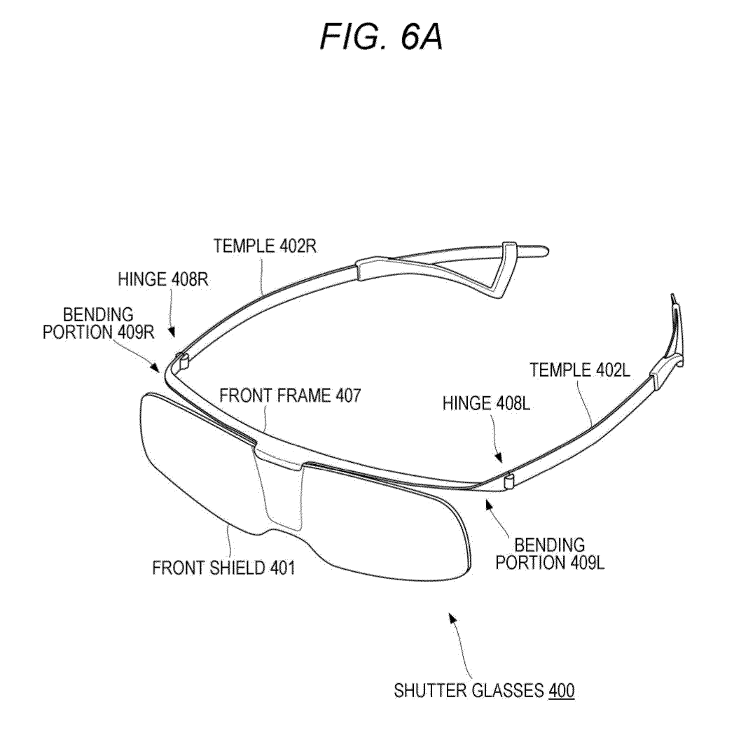

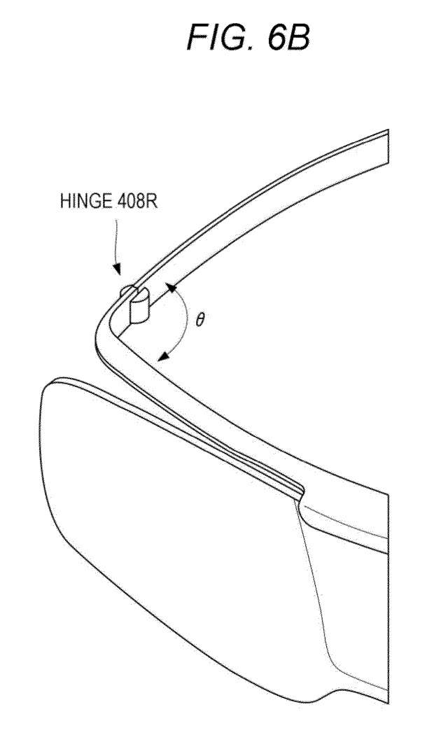

FIG. 6A illustrates a perspective view of the shutter glasses 400 in which hinges 408L and 408R connecting the front frame 407 to the temples 402L and 402R are also illustrated. FIG. 6B illustrates a perspective view of the shutter glasses 400 in which a portion near the hinge 408R is enlarged. As can be understood from the figures, in both left and right ends of the front frame 407, bending portions 409L and 409R that bend to the rear side to be approximately perpendicular are formed. As described above, the front frame 407 is manufactured using a material that has sufficient reversibility or sufficiently maintains the shape such as pure titanium. Accordingly, by adjusting angles θ of the bending portions 409L and 409R by applying external forces to portions near the bending portions 409L and 409R so as to be transformed, the angles θ are maintained. Therefore, when wearing the shutter glasses 400, a user can make the shutter glasses to fit the size or the shape of the head by transforming the angles to desired angles θ.

As can be understood from the rear-side view illustrated in FIG. 4B, in a gap between the left and right liquid crystal shutters 403L and 403R near the center of the rear-face side (the side of the face of a user wearing the shutter glasses) of the front shield 401, an electric component housing part 404 is attached. Inside the electric component housing part 404, as illustrated in FIG. 2, circuit components such as the communication unit 305, the control unit 306, and the shutter driving unit 307, the rechargeable battery 310 that is a power source for driving the circuits, and the like are housed. In addition, a nosepiece part 405 is attached to the surface of the electric component housing part 404. The nosepiece part 405 has a role of allowing the electric component housing part 404 or the front shield 401 to secure clearance so as not to be in contact with the user's face and has almost no role of supporting the shutter glasses 400 at the head part of the user. As described above, the shutter glasses can be sufficiently supported by the side pressure generated when the bending portions disposed on the rear sides of the left and right temples 402L and 402R are brought into contact with the rear head part of the user.

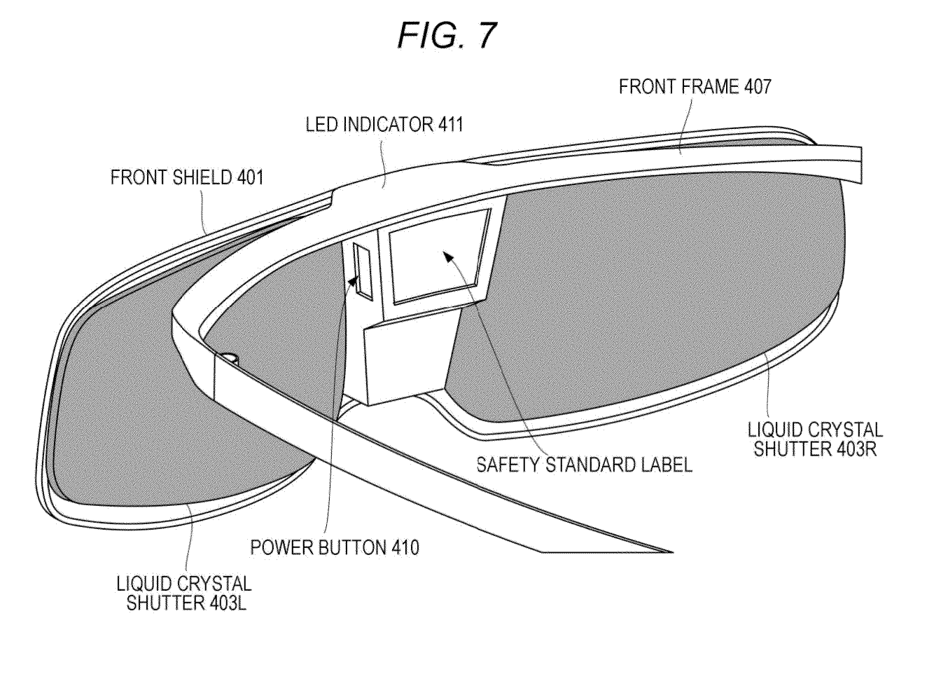

FIG. 7 illustrates the rear-face side (the side of the face of a user wearing the shutter glasses) of the front shield 401 in an enlarged scale. As described above, the electric component housing part 404 is attached near the center of the front shield 401. However, in the figure, the earpiece parts 406 are not illustrated. In the example illustrated in the figure, a predetermined safety standard label is attached to a center side face. In addition, a power button 410 is arranged on the left-side face. An LED indicator 411 used for displaying the operating status, which is arranged on the top face, emits irradiation light of LED devices to the outside through openings formed in the front frame 407. Here, the place at which the safety standard label is attached and the place at which the power button 410 is arranged are design items, and the example illustrated in FIG. 7 is merely an example.

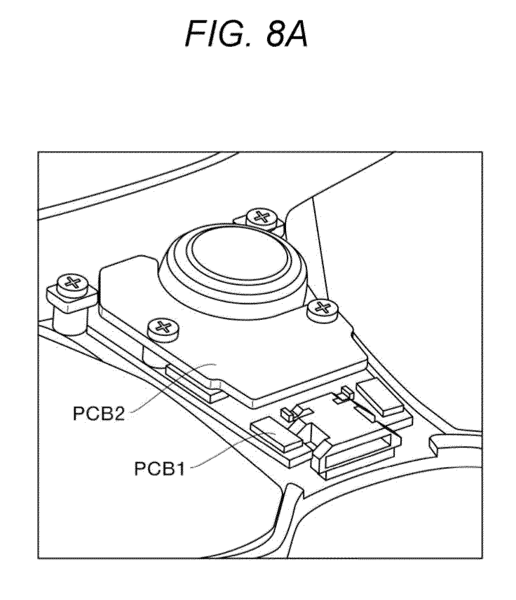

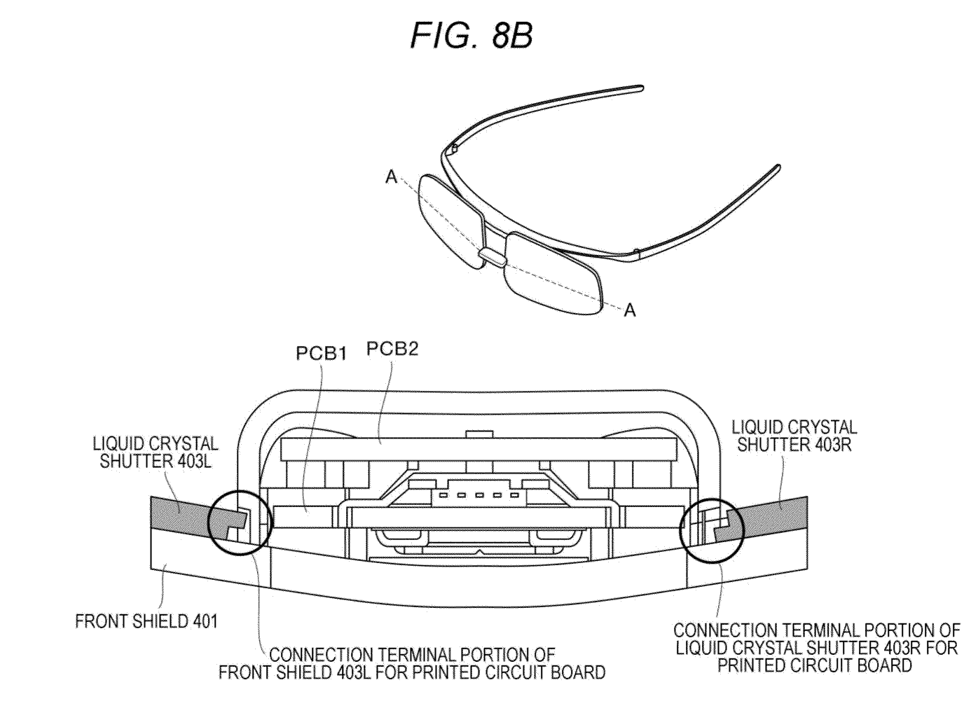

FIG. 8A illustrates an internal configuration example of the electric component housing part 404. FIG. 8B illustrates a cross-sectional view (a cross-sectional view taken along line A-A represented on the upper right side) of the electric component housing part 404. A place located on the front shield 401 in which the electric component housing part 404 can be arranged is limited to the gap between the left and right liquid crystal shutters 403L and 403R. Thus, as illustrated in FIG. 8, two printed circuit boards (PCB1 and PCB2) are arranged so as to overlap each other, and a mounting area wider than the arrangement space of the electric component housing part 404 arranged on the front shield 401 is acquired. Although not illustrated in FIG. 8, since an infrared receiving unit of the communication unit 305 faces the front-face side of the front shield 401, an infrared signal transmitted from the display apparatus 11 can be easily received over the transparent front shield 401 (in a case where infrared communication is used for communication with the display apparatus 11).

FIG. 9 illustrates a portion of the front frame 407 that supports the front shield 401 in an enlarged scale. As can be understood from the top view illustrated in FIG. 4E, while the front frame 407 is bent further toward both left and right ends, the front shield 401 has an almost flat shape. Thus, as illustrated in the figure, the front shield 401 is supported only at the center portion of the front frame 407, and both end portions of the front shield 401 of which the radius of curvature does not coincide with that of the front frame are released. In addition, as denoted by a circle in FIG. 9, an offset is arranged in the support portion so as to absorb a difference in the R (radius) on the corner.

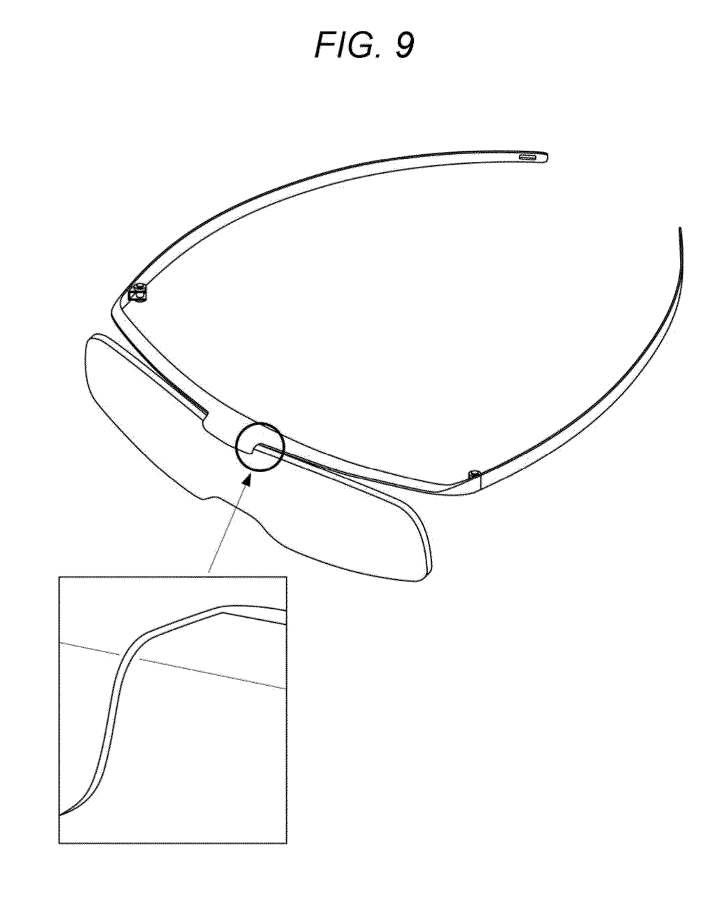

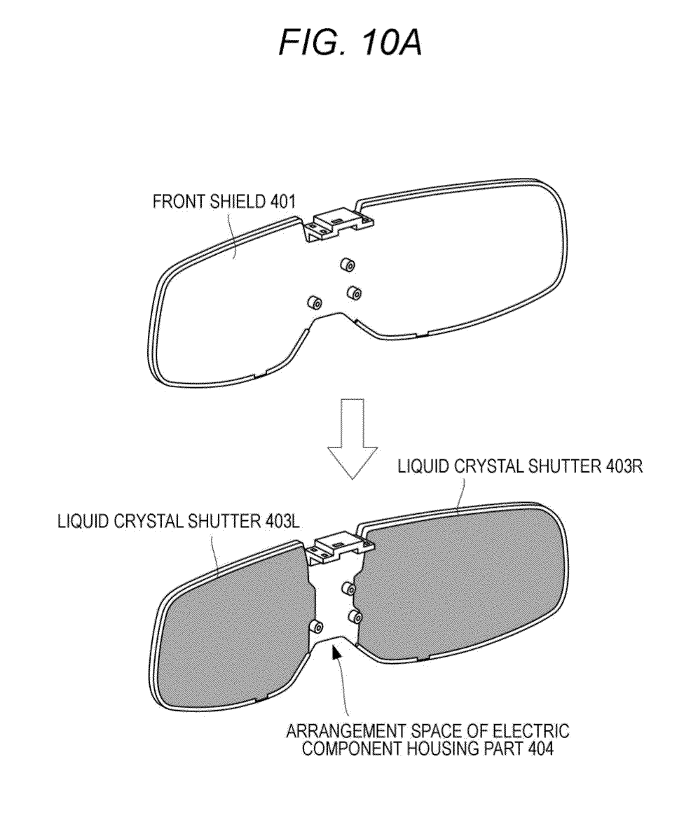

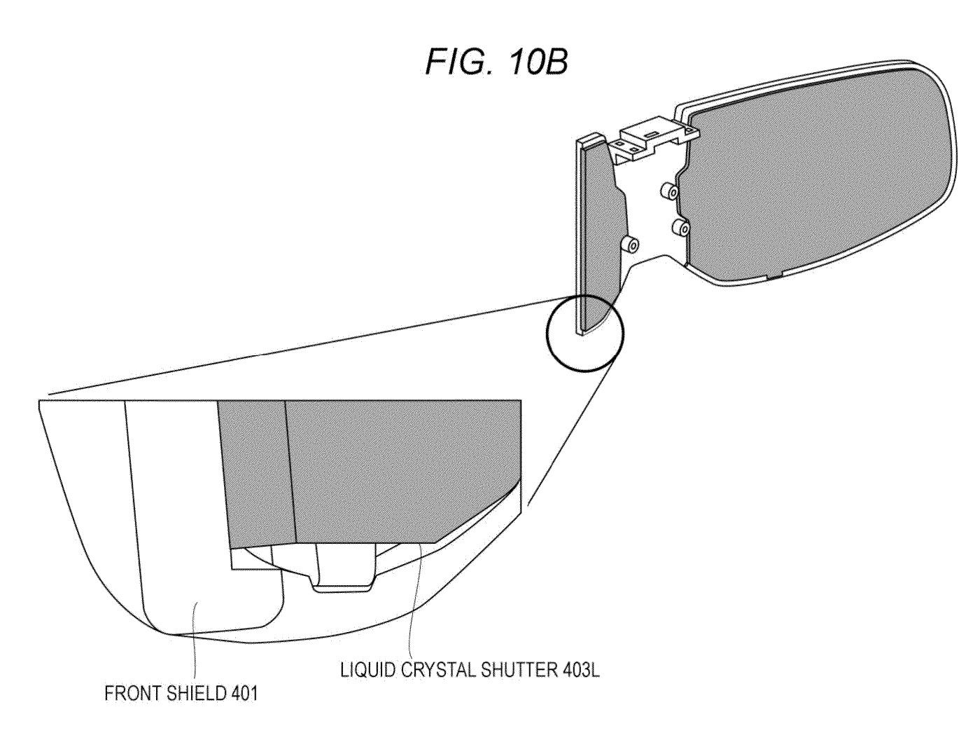

The front shield 401 is manufactured using a transparent material, and the left and right liquid crystal shutters 403L and 403R are attached to the rear face (the side of the face of the user wearing the shutter glasses), which has already been described. For example, the front shield 401 made from an acrylic resin such as poly methyl methacrylate (PMMA) can be manufactured through mold injection. In addition, as one method of attaching the liquid crystal shutters 403L and 403R to the surface of the front shield 401 made from an acrylic resin, there is “bonding”. For example, bonding may be performed using a double-sided tape, an UV resin, or the like. FIG. 10A illustrates the appearance of bonding the liquid crystal shutters 403L and 403R to the surface (rear-face side) of the front shield 401 using a double-sided tape or the like. In addition, FIG. 10B illustrates a cross-sectional view of the front shield 401 after the attachment of the liquid crystal shutter 403L. As can be understood from a lower portion of FIG. 10A, which illustrates the appearance after the bonding the liquid crystal shutters 403L and 403R, a gap that becomes the arrangement space for the electric component housing part 404 is present between the left and right liquid crystal shutters 403L and 403R.

In the liquid crystal shutters 403L and 403R bonded to the front shield 401, either a glass liquid crystal or a film liquid crystal may be used. In a case where the front shield 401 has an almost flat shape as in this embodiment, either the glass liquid crystal or the film liquid crystal may be used. On the other hand, in a case where the front shield has a curved face, for example, by being bent toward the inner side in the end edge portion, it is difficult to attach the glass liquid crystal following the curved face, and it is necessary to use the film liquid crystal.

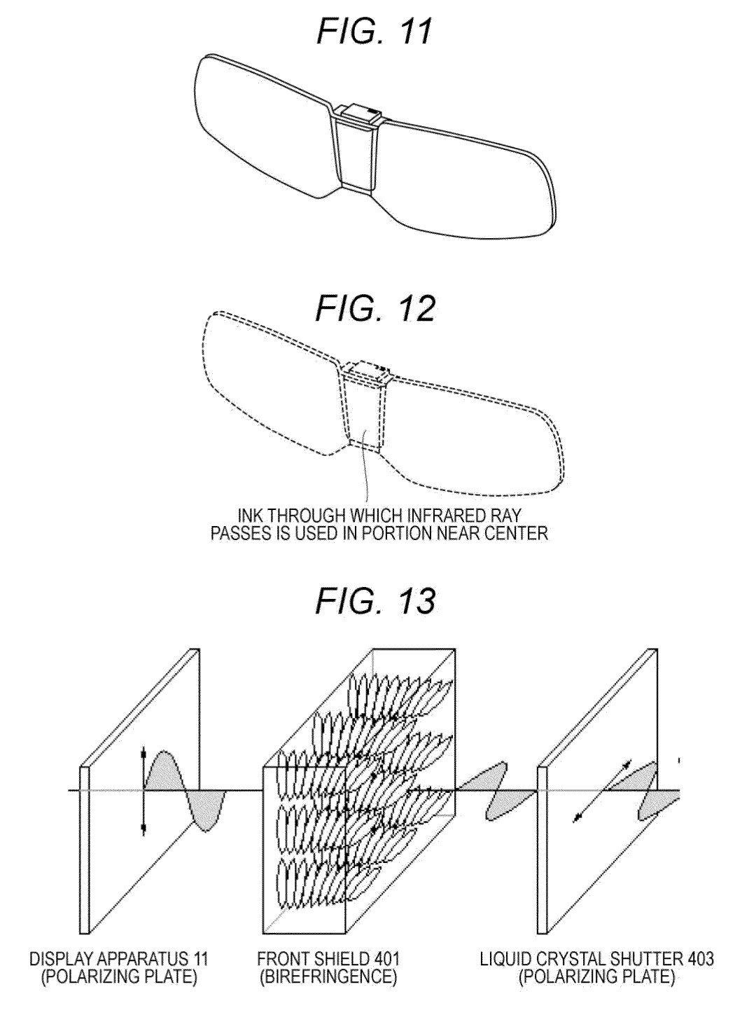

FIG. 11 illustrates the appearance of the front shield 401 projected from the front-face side. On the surface of the front shield 401 that is located on the front-face side, an IMD (in-mold decoration) film as illustrated in FIG. 12 is simultaneously molded. The infrared receiving unit of the communication unit 305 disposed inside the electric component housing part 404 faces the front-face side of the front shield 401, which has already been described. Accordingly, it is preferable to use ink through which infrared light is transmitted at least for a portion located near the center of the IMD film.

In a time-divisional stereoscopic image displaying system, the principle of presenting a stereoscopic image is that screen switching performed on the display apparatus 11 side and the opening/closing operations of the left and right liquid crystal shutters performed on the shutter glass 13 side are synchronized with each other. In other words, the display apparatus 11 alternately displays the left-eye image and the right-eye image on the screen in the frame sequential mode, and the shutter glasses 13 transmits light in the left-eye part and shields light in the right-eye part in accordance with a display period of a left-eye image and transmits light in the right-eye part and shields light in the left-eye part in accordance with the display period of a right-eye image.

In a case where a time-divisional display is performed using the shutter glasses 13 that use the liquid crystal shutters, it may be configured such that light of a display video is polarized by overlapping polarizing plates on the surface of the display panel 134 on the display apparatus 11 side, and polarized light is not transmitted by setting the polarization direction of the liquid crystal shutter by which light is shielded to intersect the amplitude direction of the polarized light.

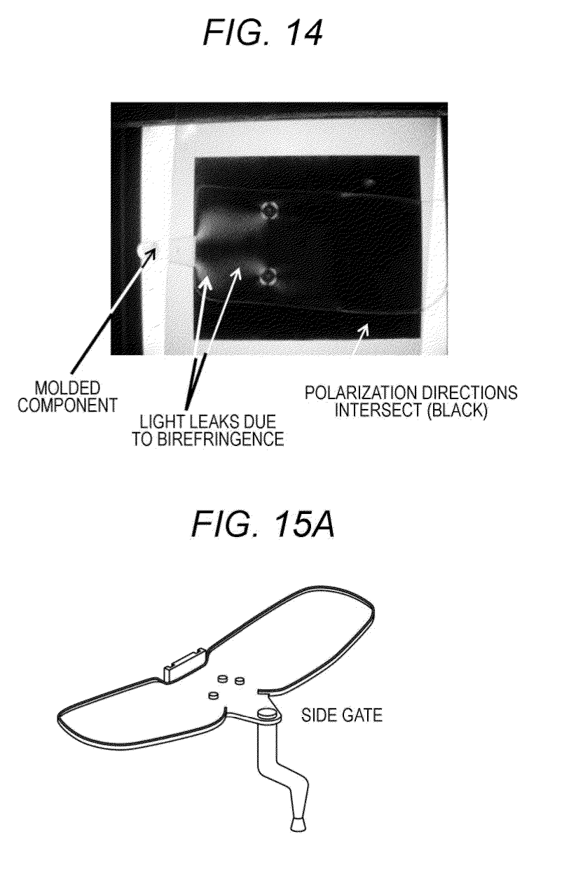

As in this embodiment, in a case where the left and right liquid crystal shutters 403L and 403R are bonded to the front shield 401 made from an acrylic resin, it is concerned that birefringence occurs when polarized light of a display video passes through the front shield 401. FIG. 13 illustrates the appearance in which a display video after polarization, which has been supplied from the display apparatus 11, passes through the front shield 401 and is shielded by the liquid crystal shutter 403. When the polarization direction of the polarizing plate overlapping the surface of the display panel 134 and the polarization direction of the liquid crystal shutter 403 (polarizing plate) are perpendicular to each other, light can be shielded. Even so, when the front shield 401 having birefringence is interposed between two polarizing plates described above, light leaks due to the birefringence. In such a case, the contrast decreases. In addition, when one of left-eye and right-eye videos is displayed, the video leaks to the other eye, and accordingly, the 3D effect reduces. FIG. 14 illustrates the appearance of light leaking when a molding component having birefringence is inserted between two polarizing plates of which the polarization directions are perpendicular to each other. Light is shielded by the two polarizing plates of which the polarization directions are perpendicular to each other, and, originally, the appearance is assumed to be dark, but, when the polarization direction changes due to the birefringence, light leaks so as to be exposed white.

In the arrangement of optical components as illustrated in FIG. 13, in a case where the polarization directions of the polarizing plate of the display apparatus 11 side and the liquid crystal shutter 403 are perpendicular to each other, a quantitative degree of leaked light, in other words, the transmittance of light is determined based on a combination of the polarization element (inclination of light) included in the front shield 401 and a phase difference element (disorder of light). It is the most preferable that the polarization elements are perpendicular (parallel to the traveling direction of light) in all the areas. In addition, it is the most preferable that the color is the same (no phase difference) in all the areas.

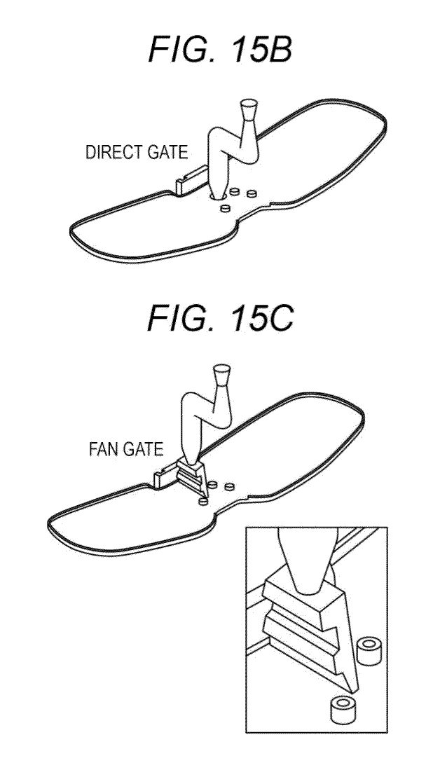

The former polarization element depends on the component shape, the type of the gate of the mold injector, the position of the gate, and the like. As the types of the gate, for example, there are a side gate (see FIG. 15A), a direct gate (see FIG. 15B), and a fan gate (see FIG. 15C). Starting from the type of the gate, depending on the molding conditions, residual stress occurs in a molded product and causes the index of refraction of light to partially change. In addition, the latter phase difference element is determined mainly by a material (including the grade of the material (correspondence or no-correspondence of birefringence)) of the component. In this embodiment, the material of the front shield 401 is determined to be PMMA.

The birefringence can be predicted by a flow analysis of mold injection. The applicants of this application selected PMMA as the material and performed the flow analysis of mold injection for each gate described above. As a result, it was found that, when mold injection of the front shield 401 is performed by the side gate, a phase difference occurs, and the polarization elements are greatly disordered. Accordingly, it is predicted that non-uniformity of the contrast greatly occurs. In addition, it was found that, when mold injection of the front shield 401 is performed by a direct gate, although the polarization elements are close to be perpendicular in a place positioned far from the gate, the polarization elements are slightly disordered near the gate. In contrast to this, it was found that, when mold injection of the front shield 401 is performed by a fan gate, the polarization elements are almost perpendicular in a place positioned far from the gate, and the range in which the polarization elements are greatly disordered near the gate is very small. Summing up, since it is apparent that the fan gate is most preferable, the applicants of this application determine to perform mold injection using the fan gate. FIG. 15C also illustrates an enlarged diagram of a portion near the gate.

The technologies disclosed in this specification may take the configuration as below.

(1) There is provided a shutter glass device including: a left-eye liquid crystal shutter unit; a right-eye liquid crystal shutter unit; a transparent shield on which the left-eye liquid crystal shutter unit and the right-eye liquid crystal shutter unit are installed; a frame unit that supports the shield; and temple units that are connected to both left and right ends of the frame unit.
(2) The shutter glass device described in (1) described above, in which the left-eye liquid crystal shutter unit and the right-eye liquid crystal shutter unit are bonded to a rear-face side of the shield.
(3) The shutter glass device described in (1) described above, in which the frame unit is made from pure titanium, and the temple units are made from a titanium alloy.
(4) The shutter glass device described in (1) described above, in which rear-side portions of the temple units bend toward the inner side.
(5) The shutter glass device described in (1) described above, further including earpiece parts that are installed near rear ends of the temple units.
(6) The shutter glass device described in (5) described above, in which the position of the earpiece part can be changed to a front or rear side along a longitudinal direction of the temple units.
(7) The shutter glass device described in (5) described above, in which the earpiece parts are manufactured in the shape of letter “V” using elastomer-based silicon or any other flexible material, a front leg of the letter “V” includes a bending portion, and a radius of curvature of the bending portion changes in accordance with a width with which legs of the letter “V” are open.
(8) The shutter glass device described in (3) described above, in which the frame unit includes bending portions bending to a rear side in both left and right ends, and the temple units are supported by the frame unit to be rotatable using hinges disposed on a further end edge side than the bending portions.
(9) The shutter glass device described in (1) described above, further including, on a rear-face side of the frame unit, an electric component housing part attached in a gap between the left-eye liquid crystal shutter unit and the right-eye liquid crystal shutter unit.
(10) The shutter glass device described in (9) described above, in which the electric component housing part houses a shutter driving circuit of the left-eye liquid crystal shutter unit and the right-eye liquid crystal shutter unit, a communication circuit that performs a reception process of an infrared signal or an RF signal, and a battery that supplies power to circuits. (11) The shutter glass device described in (9) described above, in which, in the electric component housing part, two, three, or more printed circuit boards used for mounting housed electric components are arranged in an overlapping manner.
(12) The shutter glass device described in (1) described above, in which the frame unit supports the shield in a center portion.
(13) The shutter glass device described in (1) described above, in which the shield is made from an acrylic resin that is injection-molded.
(14) The shutter glass device described in (13) described above, in which an IMD film is simultaneously molded on a surface of a front-face side of the shield.
(15) The shutter glass device described in (13) described above, in which the shield is molded so as to suppress birefringence.
(16) The shutter glass device described in (13) described above, in which the shield is injection-molded using a fan gate.

### INDUSTRIAL APPLICABILITY

As above, the technologies disclosed in this specification have been described in detail with reference to specific embodiments. However, it is apparent that a modification or a substitution in the embodiments can be made by those skilled in the art in the range not departing from the concept of the technologies disclosed in this specification.

In this specification, although embodiments applied to the shutter glasses used in the time-divisional stereoscopic image displaying system have been mainly described, the concept of the technologies disclosed in this specification is not limited thereto. The technologies disclosed in this specification can be applied to various image observation glasses starting from polarized glasses used in a polarization mode in which a stereoscopic image is presented by changing the polarization status for a right-eye image and a left-eye image.

To sum up, the technologies disclosed in this specification have been described in the exemplary form, and thus, the contents written in this specification should not be construed for purposes of limitation. In order to determine the concept of the technologies disclosed in this specification, the claims should be referred to.

### REFERENCE SIGNS LIST

11 Display apparatus
13 Shutter glasses
120 Left and right image signal processing unit
124 Communication unit
126 Timing control unit
130 Gate driver
132 Data driver
134 Liquid crystal display panel
305 Communication unit
306 Control unit
307 Shutter driving circuit
308 Left-eye shutter
309 Right-eye shutter
310 Rechargeable battery
311 LED indicator
400 Shutter glasses
401 Front shield
402 Temple
403 Liquid crystal shutter
404 Electric component housing part
405 Nosepiece part
406 Earpiece part
407 Front frame
   408 Hinge
   409 Bending portion

1. A shutter glass device comprising:
a left-eye liquid crystal shutter unit;
a right-eye liquid crystal shutter unit;
a transparent shield on which the left-eye liquid crystal shutter unit and the right-eye liquid crystal shutter unit are installed;
a frame unit that supports the shield; and
temple units that are connected to both left and right ends of the frame unit.

2. The shutter glass device according to claim 1, wherein the left-eye liquid crystal shutter unit and the right-eye liquid crystal shutter unit are bonded to a rear-face side of the shield.

3. The shutter glass device according to claim 1, wherein the frame unit is made from pure titanium, and the temple units are made from a titanium alloy.

4. The shutter glass device according to claim 1, wherein rear-side portions of the temple units bend toward the inner side.

5. The shutter glass device according to claim 1, further comprising earpiece parts that are installed near rear ends of the temple units.

6. The shutter glass device according to claim 5, wherein the position of the earpiece part can be changed to a front or rear side along a longitudinal direction of the temple units.

7. The shutter glass device according to claim 5, wherein the earpiece parts are manufactured in the shape of letter “V” using elastomer-based silicon or any other flexible material, a front leg of the letter “V” includes a bending portion, and a radius of curvature of the bending portion changes in accordance with a width with which legs of the letter “V” are open.

8. The shutter glass device according to claim 3,
wherein the frame unit includes bending portions bending to a rear side in both left and right ends, and
wherein the temple units are supported by the frame unit to be rotatable using hinges disposed on a further end edge side than the bending portions.

9. The shutter glass device according to claim 1, further comprising, on a rear-face side of the frame unit, an electric component housing part attached in a gap between the left-eye liquid crystal shutter unit and the right-eye liquid crystal shutter unit.

10. The shutter glass device according to claim 9, wherein the electric component housing part houses a shutter driving circuit of the left-eye liquid crystal shutter unit and the right-eye liquid crystal shutter unit, a communication circuit that performs a reception process of an infrared signal or an RF signal, and a battery that supplies power to circuits.

11. The shutter glass device according to claim 9, wherein, in the electric component housing part, two, three, or more printed circuit boards used for mounting housed electric components are arranged in an overlapping manner.

12. The shutter glass device according to claim 1, wherein the frame unit supports the shield in a center portion.

13. The shutter glass device according to claim 1, wherein the shield is made from an acrylic resin that is injection-molded.

14. The shutter glass device according to claim 13, wherein an IMD film is simultaneously molded on a surface of a front-face side of the shield.

15. The shutter glass device according to claim 13, wherein the shield is molded so as to suppress birefringence.

16. The shutter glass device according to claim 13, wherein the shield is injection-molded using a fan gate.
